(19) United States
(12) Patent Application Publication
(10) Pub. No.: US 2005/0146790 A1
(43) Pub. Date: Jul. 7, 2005

(54) Optical tracking system, and optical element therefore with quartic phase plate

(75) Inventors: Xinping Liu, Ottawa (CA); Xianyang Cai, Ottawa (CA)

Correspondence Address: MARKS & CLERK, P.O. BOX 957, STATION B, OTTAWA, ON, K1P 5S7, CA

(73) Assignee: National Research Council, Ottawa (CA)

(21) Appl. No.: 10/975,347

(22) Filed: Oct. 29, 2004

Related U.S. Application Data
(60) Provisional application No. 60/515,646, filed on Oct. 31, 2003.

(51) Int. Cl. G02B 1/10

(52) U.S. Cl. 359/586

(57) ABSTRACT

A phase plate having a phase-retardation function with a quartic term is located in an imaging system to increase the depth of field or depth of focus of a tracking system, such as a telescope of microscope tracking system.

### CROSS REFERENCE TO RELATED APPLICATION

This application claims the benefit under 35 USC 119(e) of prior U.S. provisional application Ser. No. 60/515,646 filed Oct. 31, 2003, the contents of which are incorporated by reference.

### FIELD OF THE INVENTION

This invention relates to the field of optical imaging systems, and in particular to imaging systems suitable for tracking distant objects, such as stars.

### BACKGROUND OF THE INVENTION

In an imaging system used to track distant objects, e.g., a star tracker, the image of the distant object is focused within one pixel of a CCD camera. For a highly accurate tracking system, the image plane is commonly defocused slightly from the best focal plane, spreading the spot image over several pixels. Thus, it is possible to determine the position of the distant object by calculating the centre of the image (the centroid) and interpolating to a small fraction of one pixel. On the other hand, it is not desirable to smear the object image on too large an area, because this will decrease the signal-to-noise ratio. The allowed defocus depth is usually very short for a conventional imaging system due to the small F-number. The tracking accuracy will be affected by large defocus caused unexpectedly by a temperature variation or a vibration. Increasing the focal depth of an imaging system would make the tracking system more resistant to environmental change.

The intensity point spread function (PSF) in the imaging plane of a conventional optical system is known to be approximated by a Gaussian function. The method of direct Gaussian fitting is usually applied to estimate the centroid position of the PSF. This method provides an efficient and accurate algorithm that can be used in an optical tracking system to locate the position of the objects being tracked. However, when misfocus occurs due to changes in the object distant or to defocus in the image plane of a conventional imaging system, the profile of the PSF might not fit into a Gaussian function, and the imaging system may fail to locate accurately the position of objects being tracked.

For greater tracking accuracy, some sort of auto-focus system can be built into the tracking system, but this is very expensive in most cases. The use of amplitude pupil plates as apodizers is a technique known to change the 3-D distribution of the point-spread function (PSF) of an optical system and extend its focal depth. A cubic phase mask has been applied to microscope imaging for focal depth enhancement.

The main drawback of the amplitude pupil plate is that there is loss of optical power in the image plane. The cubic phase mask (CPM) is non-rotational symmetric and cannot be applied to optical systems used for optical tracking.

Dobryna Zalvidea and Enrique E. Sicre, “Phase pupil functions for focal-depth enhancement derived from a Wigner distribution function,” Applied Optics, 37(17), 3623-3627 (1 Jun. 1998) discuss phase pupil functions derived from an Wigner distribution function in the context of an axilens.

### SUMMARY OF THE INVENTION

The present invention is based on the realization that the depth of field or focus of an optical system can be extended by inserting a suitable phase plate in the optical system. The present invention uses a phase plate with a phase retardation function having quartic term and preferably a quadratic term to improve the focal depth of optical systems useful for tracking objects. The phase plate, (preferably with phase-retardation function derived from a logarithmic aspheric lens) is preferably a rotational symmetrical component and can be relatively easily fabricated with precision in a modern optical workshop.

The phase plate should preferably be inserted in the pupil plane, which can be either the entrance plane or the exit plane, or the aperture stop plane of the imaging system. The entrance and exit pupils are the images of the aperture stop in the object and image space respectively. However, sometimes it is not possible to place the phase plate in the entrance pupil plane or exit pupil plane because their positions may be inside a lens or too far away from the lens.

In an embodiment of the invention there is provided an imaging system incorporating a quartic phase plate providing energy redistribution in the neighborhood of the focal plane, and the profile of the PSF remains a Gaussian distribution.

The phase plate of the invention is preferably introduced into the aperture stop or pupil plane of the optical system.

In embodiments of the invention the quartic phase function is derived from a Wigner distribution function of the form Ø(p)=−π,·α(p⁴/pₒ⁴−p²/pₒ²), and more generally
φ(ρ)=−π·(α₁·ρ⁴/ρ₀⁴−α₂·ρ²/ρ₀²) (1)
where ρ is the phase plate radial coordinate, and where ρ₀ is the effective radius of the phase plate, and where α₁ is a constant related to the desired performance and a system parameter like the focal length and the F-number, and where α₂ is another constant related to the desired focal plane's position of a lens which may have aberrations. The constant α₁ of the quartic phase function is preferably between −50 and 50, and the value of α₂ is preferably between −80 and +80. In one embodiment the value of α₁ is ±4.7, and the value of α₂ is between −8 and +8.

In general, the quartic term is used to modify the axial intensity distribution, and the quadratic term can be used to retain the focal plane's position of an aberration-free lens.

The phase-retardation function can increase the depth of field or focal depth of a lens system including lens systems which might have aberrations. An optical tracking system that incorporates this type of phase plate will be highly tolerant to focus error and resistant to environmental change. The cost of the optical tracking system can also be reduced since there will generally be no need for an expensive auto-focus system.

The phase-retardation function and a phase plate can be used to improve the depth of field or focal depth of object tracking systems. The phase-retardation function of the phase plate is preferably derived from a logarithmic aspheric lens. In certain embodiments, the phase plate comprising this phase-retardation function can be applied to tracking systems for either small objects, such as cells or components thereof, under a microscope or distant objects like stars. The phase plate is highly efficient, rotational symmetric, and relatively easy to fabricate.

### BRIEF DESCRIPTION OF THE DRAWINGS

The invention will now be described in more detail, by way of example only, with reference to the accompanying drawings, in which:—

FIG. 1 is a plot showing the axial intensity for different normalized values of axial distance k Solid: α=0; dot: α=2.0; dash-dot: α=4.6; dash: α=6.0.

FIG. 2 is a plot of the intensity distribution for different values of k. Solid: k=0; dot: k=2; dash-dot: k=4; dash: k=6.

FIG. 3 is a plot of the intensity distribution for different values of k. Solid: k=0; dot: k=−2; dash-dot: k=−4; dash: k=−6

FIG. 4 shows the configuration of an embodiment of an optical system in accordance with the invention.

FIG. 5 is a plot of an embodiment of the phase distribution associated with the pupil aperture when an embodiment of the present invention is used to enhance the focal depth.

FIGS. 6a to 6c show the intensity distribution of an embodiment of a substantially aberration-free lens.

FIGS. 7a to 7c show the intensity distribution of an optical system incorporating an embodiment of the phase plate of with the present invention.

FIG. 8 is an experimental setup used to test the phase plate.

FIGS. 9a to 9c show the intensity distribution.

FIGS. 10a to 10c show the intensity distribution of an achromatic lens for different imaging planes in the presence of a quartic plate.

FIG. 11 is a diagram of a microscope objective.

FIGS. 12a and 12b show the intensity distribution of s 100× microscope objective for z=0 (solid), z=1.0 μm; z=2.0 μm (dashed).

FIG. 13 shows the axial intensity of an objective comprising a phase plate (solid curve: 0 mm field, dotted curve: 0.1 mm field).

FIG. 14a to 14f show the intensity distribution of a lens equipped with a quartic phase plate (solid curve: intensity distribution; dotted curve: Gaussian distribution).

### DETAILED DESCRIPTION OF THE PREFERRED EMBODIMENTS

A quartic phase plate derived from a Wigner distribution function has a phase pupil function given by the expression φ(ρ)

$$ϕ ( ρ ) = exp \{ - π α [ {( \frac{ρ}{{ρ}_{0}} )}^{4} - {( \frac{ρ}{{ρ}_{0}} )}^{2} + \frac{1}{4} ] \}$$

where the value of α is related to the desired focal depth. Omitting the constant term, we can rewrite the above phase function as a normalized one:
ψ(ξ)=−π·α·└ξ⁴−ξ²┘.

Substituting, the intensity distribution in the neighborhood of the focal plane is obtained:

$$I ( r ; z ) = {\vert 2 π c {ρ}_{0}^{2} {\int }_{0}^{1} {J}_{0} [ 2 π \cdot s \cdot ξ ] • exp [ - i \cdot π \cdot α ( {ξ}^{4} - {ξ}^{2} ) ] • \\ exp [ i π \cdot k \cdot {ξ}^{2} ] \cdot ξ ⅆ ξ \vert}^{2} .$$

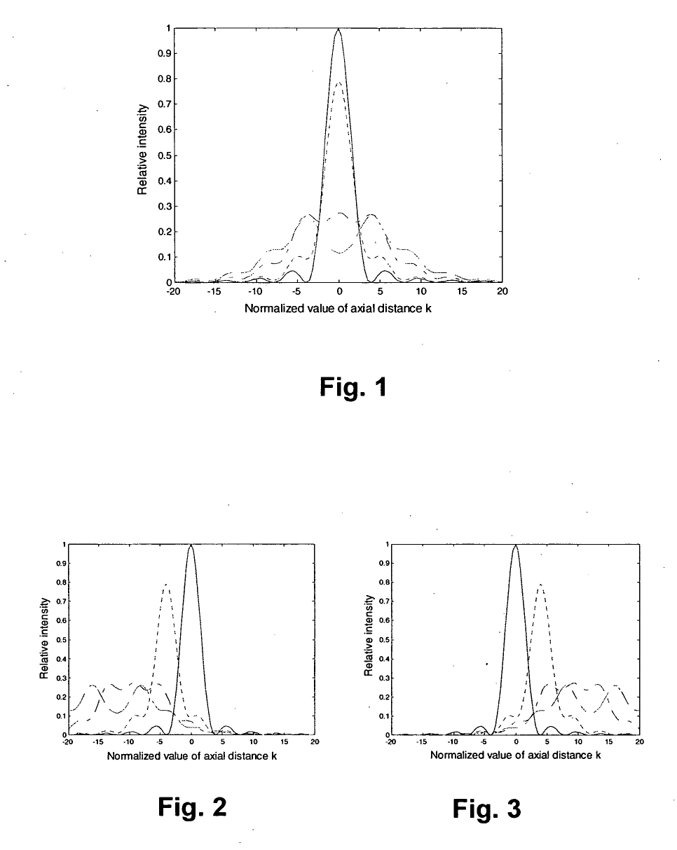

The results of substituting values of a into this equation are shown in FIG. 1. The plots show that there is no focal plane shifting for this type of phase pupil function; the optimum value of α is still 4.6 to achieve a twofold extension of the focal depth, Δk=4, and the intensity variation within the extended focal range is about 12%. Using the optimum value of α=4.6, we calculate the intensity distribution near the focal plane. FIGS. 2 and 3 show the results when the focal range is shifted positively and negatively, respectively. It can be seen from the two figures that the axial intensity changes slowly during defocus, and another important observation is that the intensity profiles retain a very good single peak distribution in the image plane despite considerable focus error. This is extremely useful when applying the optical system to small object tracking.

During the above simulation, it was found that a quartic phase pupil function with coefficient α=4.6 achieved a twofold extension of the focal depth, and this result was independent of a specific lens system. So the same amount of focal depth enhancement can be achieved for any imaging system with this pupil phase function. Besides, the quartic phase plate retains the focal range of the optical system, which cannot be achieved with a simple quartic phase function derived from a logarithmic axilens.

FIG. 4 shows a complex lens system generally designated 10 comprising a series of lenses 12 for correcting aberrations and the like in a manner known in the prior art. The complex lens system 10 can be used in a variety of applications, including in optical tracking systems for small objects under a microscope or distant objects like stars or for small objects under a microscope.

The lens system 10 has an aperture stop plane 14 and an image plane 16. A CCD (charge-coupled device) sensor array 18 is placed in the image plane and light from a distant star is focused onto the image plane 16, or more precisely slightly defocused so as to spread the light over more than one pixel of the CCD array.

In accordance with an embodiment of the invention a quartic phase plate 20 is located in the aperture stop plane to increase the depth of focus of the system.

The optical system 10 has an effective focal length of 27 mm, an F-number of 1.6, a field of view of 20 degrees, and a wavelength range of 0.5˜0.75 μm.

The phase-retardation function of the phase plate 20 is described by the following equation:
φ(ρ)=−π·(α₁·ρ⁴/ρ₀⁴−α₂·ρ²/ρ₀²), (1)
where ρ is the phase plate radial coordinate, and where ρ₀ is the effective radius of the phase plate, and where α₁ is a constant related to the desired performance and a system parameter like the focal length and the F-number, and where α₂ is another constant related to the desired focal plane's position of a lens which may have aberrations.

The phase plate 20 is an aspheric optical element that can be fabricated in a known manner by means of computer-controlled grinding and polishing equipment or formed by evaporative or sputtering techniques. The phase plate described herein was fabricated using computer-controlled grinding equipment.

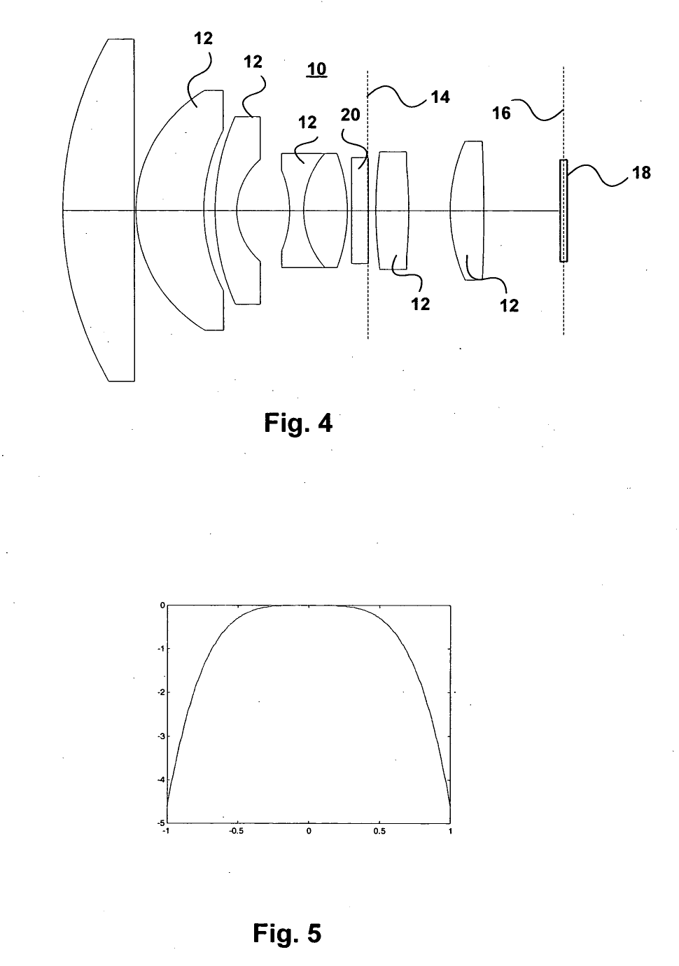

The value of α₁ for an effective extension of the focal depth is calculated to be in the range between −50˜50. FIG. 5 is a sample plot of the phase distribution of the pupil function for α₁=4.7 and α₂=0.

When very small objects or particles are typically observed or tracked under a microscope, the image size of each object usually occupies several tens of pixels in a CCD camera used to detect the image. The energy distribution of the image is an approximate Gaussian function. However, the depth of field of conventional microscopes is usually very small, and tracking small objects is limited to a very narrow range of field depths.

The quartic phase plate 20 increases the field depth of the system and retains the image profile Gaussain function in the extended depth of field.

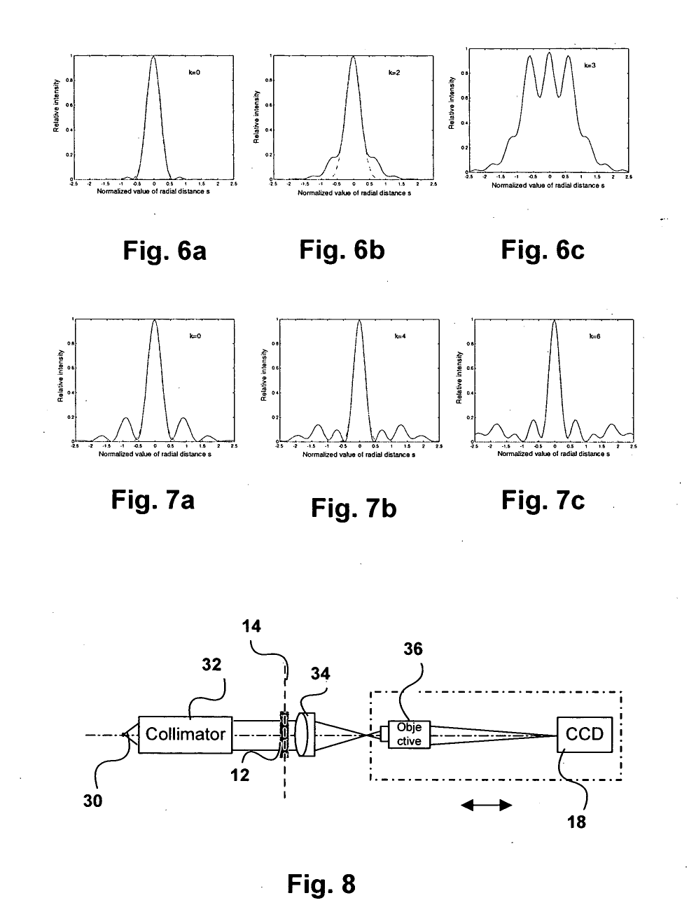

The following figures demonstrate the function of an embodiment of the quartic phase plate. FIGS. 6a to 6c show the intensity distribution of a substantially aberration-free lens and the fitted Gaussian distribution for different defocus values. It will be seen from these figures that for a large value of k (more than 3), where k represents the normalized defocus value, the profile of the intensity distribution is no longer a single peak pattern, which means that the centroid of the image cannot be calculated by means of the Gaussian fitting method.

FIGS. 7a to 7c show the intensity distribution of an optical system incorporating the novel phase plate, with a value of α₁ equal to 4.7, and the fitted Gaussian distribution for different defocus values. These figures show that focal depth is enhanced more than twofold after the quartic phase plate is inserted in the pupil plane.

When tracking distant objects like stars, the star image size is typically focused within one pixel of a CCD camera by means of an imaging lens. To achieve sub-pixel tracking accuracy, the lens system is typically slightly defocused and the image size is spread over several pixels. See, for example, Joseph F. Kordas, Isabella T. Lewis, Bruce A. Wilson, et al., “Star tracker stellar compass for Clementine mission,” SPIE, 2466, 70-83 (April 1995); G. Borghi, D. Procopio, M. Magnani, et al., “Stellar reference unit for CASSINI mission,” SPIE, 2210, 150-161 (April 1994); and Kazuhide Noguchi, Koshi Sato, Ryouichi Kasikawa, etc.,“CCD star tracker for attitude determination and control of satellite for space VLBI mission,” SPIE, 2810, 190-200 (August 1996), the contents of which are herein incorporated by reference.

In the case of the embodiment shown in FIG. 4, the quartic phase plate 20 inserted in the aperture stop plane is described by
z=6.2×10⁻⁶×ρ⁴, (4)
where the effective semi-diameter is 6.3 mm.

The focal depth is extended more than threefold as compared to an optical system comprising no phase plate.

The quartic phase plate 20 can be used to maintain the image energy distribution within a specific range in a fairly large focal range. This effectively increases the accuracy of the tracking system and makes the system more resistant to focus errors caused by environmental changes.

### EXAMPLE 1

On the basis of previous analyses, a quartic phase plate was fabricated using computer grinding techniques. The surface sag of the phase plate was described by
z==8×10⁻⁵ρ²−1.42×10⁻⁶ρ⁴
where 0≦ρ≦7.5 mm.

The effect of the phase plate on an imaging lens was tested using the setup shown in FIG. 8. In this setup a line source 30 as collimated with collimator 21 and passed through the phase plate 12 in the pupil plane 14 to the achromatic lens 34 (ƒ′=95 mm) and through the 50× objective 36 to the CCD camera 18.

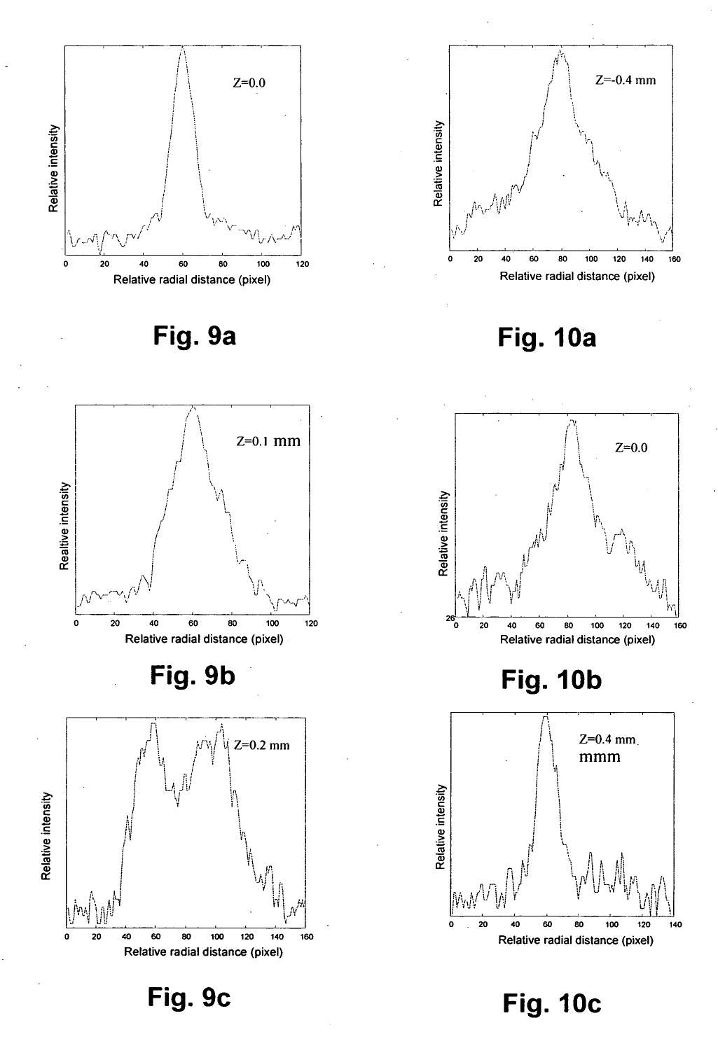

In the first experiment the tested lens was simply achromatic with a focal length of 95 mm and a diameter of 15 mm. The variation of the line-spread function (LSF) with defocus is shown in FIGS. 9a to 9c. Both the intensity and profiles of the LSF change quickly as the defocus increases. When the defocus exceeds 0.2 mm, the profile becomes a double peak, and this type of distribution is hardly Gaussian fitted.

FIGS. 10a to 10c show the line spread function variations during defocus when the same achromatic lens was used, but with the phase plate placed in the pupil plane of the lens. As predicated, the intensity profile was broadened when the phase plate was inserted, but it retained a relatively uniform distribution for a larger range of focal depth compared with a normal achromatic lens. The focal depth was extended at least twofold. Another important point is that the LSF profiles remain single peak and Gaussian fitting can be applied to locate the position of the peak, in spite of the considerable defocus error.

Thus it will be seen that in an embodiment of the invention there is provided an optical system comprising the quartic phase plate described above. In some instances, the quartic phase plate is preferably inserted near the aperture stop plane of the optical system. In some instances the optical system is a lens system. The quartic phase plate may be set in the pupil plane of an optical system useful to increase the focal depth of the optical system.

### EXAMPLE 2

A lens of the type shown in FIG. 4 and that could be used specifically as the objective in the telescope of a star tracker to extend the depth of focus was modeled. The focal length of the lens is 30.0 mm, the F-number is 2, the working range of the wavelength is 0.5˜0.75 ρm, and the field of view is 20 degrees. Near the aperture stop, a thin parallel plate having a specified thickness is normally provided during the design of the lens.

The phase variation of the plate is described by following equation:
φ(ρ)=π·[α₁·ρ²−α₂·ρ⁴],
where values of coefficients α₁ and α₂ are calculated according to the same criterion given above, i. e., in the extended focal range, the image spot size which contains 80% total energy is kept in the range of 30-50 μm; ρ is the radial coordinate of the plate. Through intensive calculations and optimization, an optimized phase function was found, which is described as follows:
φ(ρ)=1.11π·ρ²−0.0554π·ρ⁴ (ρ≦4.3 mm).
The maximum phase change is found to be less than 6π within the aperture of the plate. If the phase plate is obtained by changing the surface sag of a glass plate, then the surface sag of the phase plate is given by

$${S}_{z} ( ρ ) = \frac{λ}{2 π} \cdot Δ n \cdot ϕ ( ρ )$$

where Δn is the difference between the refractive index of the glass and the medium around the phase plate. As the phase change is very small for this phase plate, the corresponding sag variation is also very small for conventional glass. This means that it is difficult to make this plate using the conventional grinding/polishing process for a normal lens. It is therefore recommended that this phase plate be made by means of thin film coating, chemical etching or laser burning to change the refractive index of the glass.

Because of the quadric term α₁, the focal length of the lens is changed to 29.8 mm, which is smaller than that of the lens comprising no phase plate. The lens distortion is changed a little after the phase plate is introduced, but this change does not affect the accuracy of the star tracker since the calculation for position tracking can be based on the new distortion data and focal length. Table 1 gives the relative distortion values of three wavelengths, 0.50 μm, 0.59 μm and 0.75 μm.

TABLE 1

| | Distortion (%) | | |
|---|---|---|---|
| Field angle (deg) | 0.5 μm | 0.59 μm | 0.75 μm |
| 0 | 0 | 0 | 0 |
| 2 | −0.149 | −0.148 | −0.146 |
| 4 | −0.591 | −0.588 | −0.580 |
| 6 | −1.313 | −1.309 | −1.294 |
| 8 | −2.281 | −2.283 | −2.265 |
| 9.4 | −3.071 | −3.085 | −3.07 |
| 10 | −3.427 | −3.449 | −3.438 |

This table shows that the relative distortion at a field angle of 10 degrees is 3.45% for a wavelength of 0.59 μm, and that the distortion values for two wavelengths, 0.50 μm and 0.75 μm, are the same at a field angle of 9.4 degrees. The difference in distortion between wavelengths of 0.50 μm and 0.59 μm at a field angle of 10 degrees is 0.022%. In order to clearly show the performance changes of the lens, with or without an aspherical plate, the data in Table 2. The effective focal length of the new lens is decreased 0.53%, and that the distortion at a field angle of 10 degrees is increased 0.06%.

TABLE 2

| | Conventional | |
|---|---|---|
| Performance | lens | New lens |
| Effective focal length | 30 mm | 29.84 mm |
| Spot size | 30˜50 μm | 30˜50 μm |
| Entrance pupil diameter | 15 mm | 15 mm |
| Field of view | 20 deg | 20 deg |
| Wavelength range | 0.50 μm˜0.75 | 0.50 μm˜0.75 |
| Defocusing depth/focal depth | 40 μm | 145 μm |
| Distortion at a field angle of 10 degrees | −3.39% | −3.45% |
| Different distortions for | 0.026% | 0.022% |
| two wavelengths, 0.59 μm | | |
| and 0.50 μm, at a field | | |
| angle of 10 degrees. | | |

### EXAMPLE 3

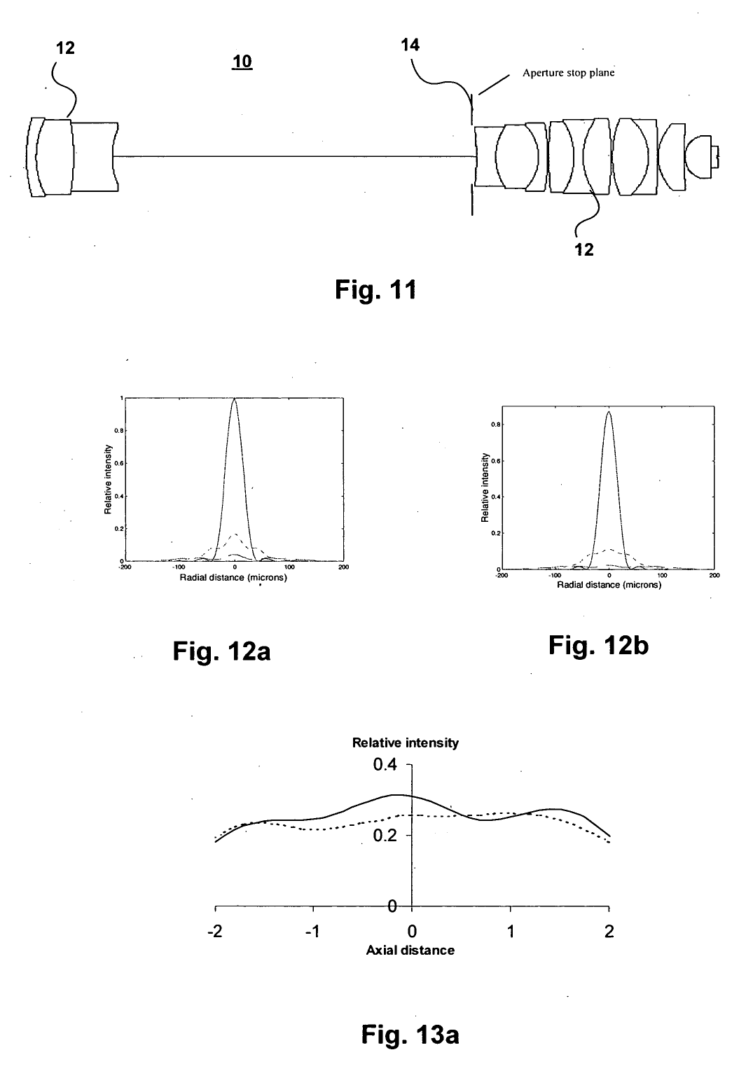

The effect of the phase plate on the depth of field of a microscope objective as shown in FIG. 11 was investigated. Such an objective is of the type described in U.S. Pat. No. 5,469,299, the contents of which are herein incorporated by reference. The numerical aperture of the objective is 0.8, the effective focal length is 2 mm and the field of view is 0.2 mm. The profiles of the intensity PSF for the two fields at three axial distance values of 0, 1 μm and 2 μm are given in FIGS. 12(a) and 12(b), respectively. These plots show that the relative axial intensity drops to 0.11 and that the profile of the intensity PSF is not easily fitted into a Gaussian function for a field of 0.1 mm at an axial distance of 1 μm. Therefore, the depth of field for the objective is less than 1 μm, if it is to be used for particle tracking.

When a quartic phase plate described by the equation
ψ(ξ)=−π·α·[ξ⁴−ξ²]
is introduced in the pupil plane of the objective, the behavior of the objective changes with an extension of its depth of field. Considering the aberrations of the actual objective lens, the optimum coefficient a for the quartic phase plate is slightly different from that used for a perfect lens, and the value of α is changed to −4.64 for optimum performance. The maximum phase variation is 1.2π. If the phase variation is obtained by changing the surface sag of an optical glass plate, then the surface sag of the phase plate is given by

$${S}_{z} ( ρ ) = \frac{λ}{2 π} \cdot ϕ ( ρ ) / Δ n$$

where Δn is the difference between the refractive index of the optical glass and the medium around the phase plate. As the phase variation is very small for this phase plate, the corresponding sag variation is also very small for conventional optical glass. This means that it is difficult to make this plate using the conventional grinding/polishing process for a normal lens. It is therefore recommended that this phase plate be made by means of thin film coating, chemical etching, laser burning to change the refractive index of the glass or other methods. In this paper we do not discuss the fabrication of this kind of phase plate.

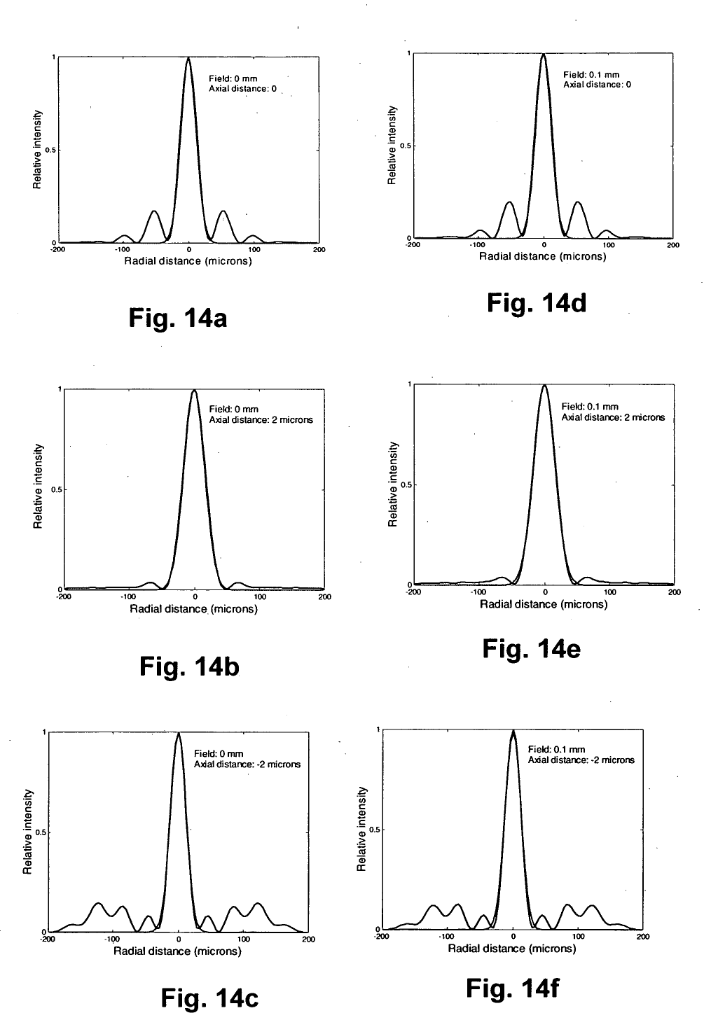

Assuming that the phase plate is made of BK7, the surface profile of the plate is described as follows
z=−0.00065·r²+0.00016·r⁴
where z is the sag of the surface, and the effective half-diameter r of the phase plate is 2.02 mm. When the above-mentioned phase plate is inserted near the aperture stop plane of the objective, the optimum object distance remains the same as that of the original objective. If the axial intensity of the focused image of the original objective is defined as 1, the axial intensity variations of the new objective for fields of 0 and 0.1 mm are shown in FIG. 13. It can be seen that the axial intensity remains above 0.18 when the object plane shifts ±2 μm. The plots of the intensity PSF for three axial distances (0 μm, 1 μm and 2 μm) are given in FIGS. 14a to 14f, which show that the intensity distribution can still be fitted into a Gaussian function despite object plane shifting. This is true for both the on-axial point and the 0.1 mm field. The position tolerance of the object plane is about ±2 μm, which is more than twofold that of a normal objective.

It will thus be seev that the quartic phase plate can be used to increase the depth of field of a 100× microscope objective more than twofold.

It will thus be appreciated by persons skilled in the art that the focal depth or depth of field of an optical system can be extended by inserting a suitable phase plate in the pupil plane. The present application disclosed a quartic phase-retardation function, containing the fourth order and second order term, which can be used to improve the depth of field of optical systems having aberrations used to track very- small objects under a microscope and the focal depth of a distant object tracking system such as a star tracker. Inserting this type of phase plate, which is rotational symmetric, in the pupil plane of a tracking optical system can enhance the focal depth or depth of field of the system.

1. An optical element comprising a phase plate having a phase-retardation function with a quartic term.

2. The optical element of claim 1, wherein said phase-retardation function also has a quadratic term.

3. The optical element of claim 2, wherein said phase retardation function is described by φ(ρ)=−π·(α₁·ρ⁴/ρ₀⁴−α₂·ρ²/ρ₀²)
where ρ is the radial coordinate of the phase plate, ρ₀ is the effective radius of the phase plate, and α₁ and α₂ constants.

4. The optical element of claim 3, wherein the value of α₁ lies in the range −50 to +50 and the value of α₂ lies in the range −80 to +80.

5. The optical element of claim 1, wherein said phase plate is derived from a logarithmic aspheric lens.

6. An optical imaging system comprising:
a plurality of lenses; and
a phase plate having a phase-retardation function with a quartic term disposed in said imaging system to increase the depth of field or depth of focus.

7. The optical imaging system of claim 6, wherein said phase plate is located in or near a pupil plane of said imaging system.

8. The optical imaging system of claim 6, wherein said phase plate is located in or near an aperture stop plane of said imaging system

9. The optical imaging system of claim 6, wherein said phase-retardation function also has a quadratic term.

10. The optical imaging system of claim 9, wherein said phase retardation function is described by φ(ρ)=−π·(α₁·ρ⁴/ρ₀⁴−α₂·ρ²/ρ₀²)
where ρ is the radial coordinate of the phase plate, ρ₀ is the effective radius of the phase plate, and α₁ and α₂ constants.

11. The optical imaging system of claim 10, wherein the value of α₁ lies in the range −50 to +50 and the value of 0:2 lies in the range −80 to +80.

12. The optical imaging system of claim 11, having an effective focal length of about 27 mm, an F-number of 1.6, a field of view of 20 degrees, and a wavelength range of 0.5˜0.75 μm, an effective semi-diameter of 6.3 mm, and where the phase plate is described by z=6.2×10⁻⁶×ρ⁴.

13. An optical tracking system comprising:
an optical sensor array;
an optical imaging system for imaging a distant object onto said sensor array; and
a phase plate having a phase-retardation function with a quartic term located in said imaging system to increase the depth of field or depth of focus thereof.

14. The optical tracking system of claim 13, wherein said phase plate is located in or near an aperture stop plane of said imaging system.

15. The optical tracking system of claim 13, wherein said phase plate is located in or near a pupil plane of said imaging system.

16. The optical tracking system of claim 13, wherein said phase-retardation function also has a quadratic term.

17. The optical tracking system of claim 16, wherein said phase retardation function is described by φ(ρ)=−π·(α₁·ρ⁴/ρ₀⁴−α₂·ρ²/ρ₀²)
where ρ is the radial coordinate of the phase plate, ρ₀ is the effective radius of the phase plate, and α₁ and α₂ constants.

18. The optical tracking system of claim 17, wherein the value of α₁ lies in the range −50 to +50 and the value of α₂ lies in the range −80 to +80.

19. The optical tracking system of claim 13, wherein said optical imaging system is a microscope objective and said phase plate increases the depth of field of said microscope objective.

20. The optical tracking system of claim 13, wherein said optical imaging system is a telescope objective and said imaging system increases the depth of focus of said telescope objective.

21. A method of enhancing the tracking capability of an imaging system comprising inserting a phase plate having a phase-retardation function with a quartic term in said imaging system.

22. The method of claim 21, wherein said phase-retardation function also has a quadratic term.

23. The method of claim 22, wherein said phase retardation function is described by φ(ρ)=−π·(α₁·ρ⁴/ρ₀⁴−α₂·ρ²/ρ₀²)
where ρ is the radial coordinate of the phase plate, ρ₀ is the effective radius of the phase plate, and α₁ and α₂ constants.

24. The method of claim 23, wherein the value of al lies in the range −50 to +50 and the value of α₂ lies in the range −80 to +80.
